(19) United States
(12) Patent Application Publication
(10) Pub. No.: US 2006/0170733 A1
(43) Pub. Date: Aug. 3, 2006

(54) Ink-jet printing device and method for fabricating LCD device using the same

(75) Inventors: Myoung-Ho Lee, Gyeonggi-do (KR); Jeong-Hyun Kim, Gyeonggi-do (KR)

Correspondence Address: JENKENS & GILCHRIST, P.C., 901 15TH STREET N.W., SUITE 900, WASHINGTON, DC, 20005, US

(73) Assignee: LG.PHILIPS LCD CO., LTD.

(21) Appl. No.: 11/315,341

(22) Filed: Dec. 23, 2005

(30) Foreign Application Priority Data
Feb. 1, 2005 (KR) 9247/2005

(51) Int. Cl. B41J 2/04

(52) U.S. Cl. 347/54

(57) ABSTRACT

An ink-jet printing device including at least one head having a plurality of nozzles, a nozzle detecting unit for real time assessing of whether a liquid material is normally discharging from the nozzles, and a liquid material supplying unit for supplying liquid material to the head.

The present invention claims the benefit of Korean Patent Application Number 9247/2005 filed in Korea on Feb. 1, 2005, which is hereby incorporated by reference in its entirety.

### BACKGROUND OF THE INVENTION

1. Field of the Invention

The present invention relates to a printing device, and more particularly, to an ink-jet printing device and a method for fabricating a liquid crystal device (LCD) device using the same. Although the present invention is suitable for a wide scope of applications, it is particularly suitable for real time detecting of a defective nozzle.

2. Description of the Background Art

A cathode ray tube (CRT) often referred to as a Braun tube has been typically used as a modern information display. However, due to users' demands for a display having a large size, a thin profile and a high resolution, light weight flat display devices having high brightness, high efficiency, high resolution and fast response capabilities are being developed to replace the CRT, which are heavy and bulky. Such flat display devices include a liquid crystal display (LCD) device, an electro-luminescent display (ELD) device, a field emitter display (FED) device, and a plasma display panel (PDP). To fabricate such high-performance flat display devices at a low cost, a screen printing method, a photosensitive pasting method with a photolithography process, and an ink-jet printing method are being actively researched.

In the screen printing method, a paste to be deposited is printed on a substrate for a display device, then the paste is dried at a temperature of 120°˜150° C., and then the paste is fired at a temperature of 550°˜600° C. The screen printing method has advantages in that the processes are simple and the processing equipment is inexpensive. However, the screen printing method can not be used to manufacture a display device having fine pitch due to the non-uniform print thickness and width of a screen printed paste.

In the photosensitive pasting method with a photolithography process, a paste to be deposited is screen-printed or spin-coated on a substrate of a display device. Then, the paste is dried, exposed, and patterned. The patterned paste is then fired to remove a solvent so as to harden the paste, thereby forming a deposition film. The photosensitive pasting method with a photolithography process can be used to make a display device having a high pitch due to the uniform print thickness and uniform width of the deposition film, which can be less than 3 μm. However, the photosensitive pasting method with a photolithography process has disadvantages. The material cost in the photosensitive pasting method with a photolithography process is high because material loss is great during manufacture. Further, fabrication processes, such as the exposure process and patterning process are complicated and require the use of expensive equipment.

To compensate for the disadvantages of the screen printing method and the photosensitive pasting method, an ink-jet printing method has been proposed. According to the related art ink-jet printing method, a material is discharged onto a substrate of a display device from a nozzle by pressurization in a desired pattern. The related art ink-jet printing device will be explained with reference to FIG. 1.

FIG. 1 is a perspective view of an ink-jet printing device in accordance with the related art. As shown in FIG. 1, the related art ink-jet printing device 10 includes a liquid material supplying unit 60 containing a liquid material 50 to be dispensed, and a head 20 for dispensing the liquid material 50 through a nozzle 25 of the head 20. The head 20 of the ink-jet printing device 10 is positioned such that the liquid material 50 will be dispensed onto a corresponding part of a printing medium 70. When the head 20 is properly positioned, the liquid material 50 is discharged or dispensed onto the printing medium 70.

The head 20 is provided with a piezoelectric device (not shown) and the nozzle 25 through which the liquid material 50 is discharged. When a voltage is supplied to the piezoelectric device, a physical pressure is generated so that a flow path between the liquid material 1 supplying unit 60 and the nozzle 25 is repeatedly contracted and expanded. Because of the contraction/expansion phenomenon of the flow path, the liquid material 50 is discharged from the nozzle 25.

The related art ink-jet printing device has the following disadvantage. After the liquid material is discharged from the nozzle, a part of the liquid material remains on a surface of the head at or about the nozzle. That is, when the liquid material is repeatedly discharged from the nozzle, the surface of the head at the nozzle becomes wet with the liquid material, which can then harden. As a result, hardened material accumulates about the nozzle. The accumulated hardened material can cause subsequently dispensed liquid material to discharge incorrectly or the accumulated hardened material can actually block the nozzle. Thus, distribution quality of the liquid material can be degraded by such hardened accumulated material. An improper dispensing of the liquid material causes the quality of the end product to be degraded. To solve this problem, a procedure of cleaning the nozzle periodically by dipping the head in a solvent having the same polarity as the liquid material to be dispensed has been adopted. However, the cleaning procedure serves only to clean a nozzle without solving the problem of incorrect dispensing due to a partially or totally blocked nozzle.

### SUMMARY OF THE INVENTION

Accordingly, the present invention is directed to an ink-jet printing device and a method for fabricating an LCD device using the same that substantially obviates one or more of the problems due to limitations and disadvantages of the related art.

An object of the present invention is to provide an ink-jet printing device capable of replacing the function of a defective nozzle with a normal nozzle by real time assessing for a defective nozzle, and a method for fabricating a liquid crystal display (LCD) device using the same.

To achieve these and other advantages and in accordance with the purpose of the present invention, as embodied and broadly described herein, there is provided an ink-jet printing device including at least one head having a plurality of nozzles, a nozzle detecting unit for real time assessing of whether a liquid material is normally discharging from the nozzles, and a liquid material supplying unit for supplying liquid material to the head.

In another aspect, a method for fabricating an LCD device using the ink-jet printing device includes preparing at least one head having a plurality of nozzles, assessing whether liquid material is normally discharged from each of the nozzles, and supplying the liquid material to the head.

In another aspect of the present invention, the method for fabricating an LCD device using the ink-jet printing device includes preparing a first substrate on which a plurality of thin film transistor arrays are formed, and a second substrate on which a color filter is formed, supplying liquid alignment material to the first substrate and to the second substrate through at least one head having a plurality of nozzles, assessing whether the liquid alignment material is normally discharged from the nozzles, and depositing the liquid alignment material discharged from the nozzles on the first substrate and the second substrate to form alignment layers on the first and second substrates.

In yet another aspect of the present invention, a method for fabricating an LCD device using an ink-jet printing device includes preparing a first substrate on which a plurality of thin film transistor arrays are formed and a second substrate on which a color filter is formed, supplying liquid material to the first substrate and the second substrate through at least one head having a plurality of nozzles, assessing whether the liquid alignment material is normally discharged from the nozzles, depositing the liquid alignment material discharged from the nozzles on the first substrate and the second substrate to form alignment layers on the first and second substrates, performing a rubbing process on the alignment layer; attaching the first substrate and the second substrate to each other, and forming a liquid crystal layer between the first substrate and the second substrate.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic view showing a lateral surface of ink-jet printing device in accordance with a related art;

FIG. 2 is a schematic view showing an ink-jet printing device and a method for discharging a liquid material onto a printing medium using the ink-jet device according to an embodiment of the present invention;

FIG. 3 is a schematic view of an ink-jet printing device according to an embodiment of the present invention;

FIG. 4 is a schematic view showing a surface of the head in an ink-jet printing device according to an embodiment of the present invention; and

FIG. 5 is a flowchart of a method for fabricating a liquid crystal display device using the ink-jet printing device according to an embodiment of the present invention.

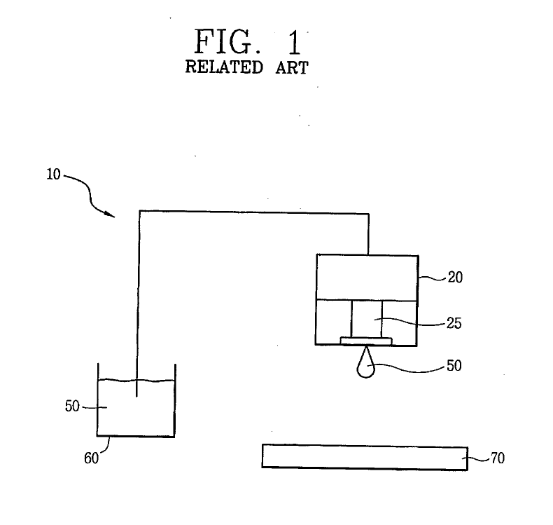

### DETAILED DESCRIPTION OF THE INVENTION

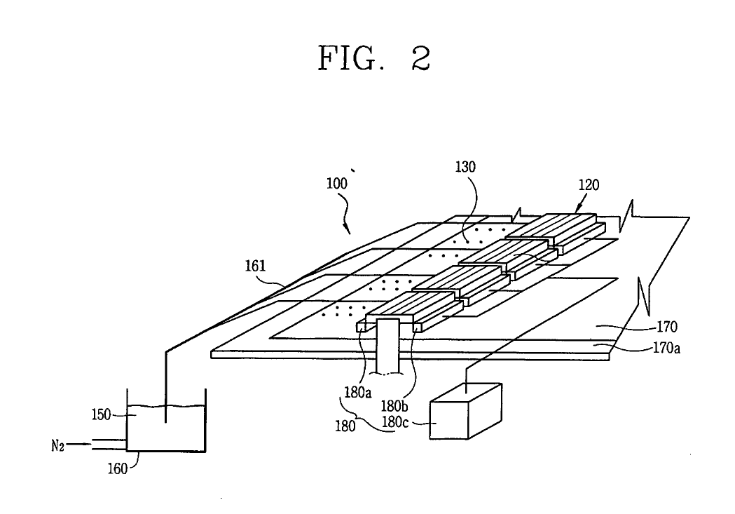

Reference will now be made in detail to the preferred embodiments of the present invention, examples of which are illustrated in the accompanying drawings. Hereinafter, an ink-jet printing device according to the present invention will be explained with reference to FIGS. 2-5.

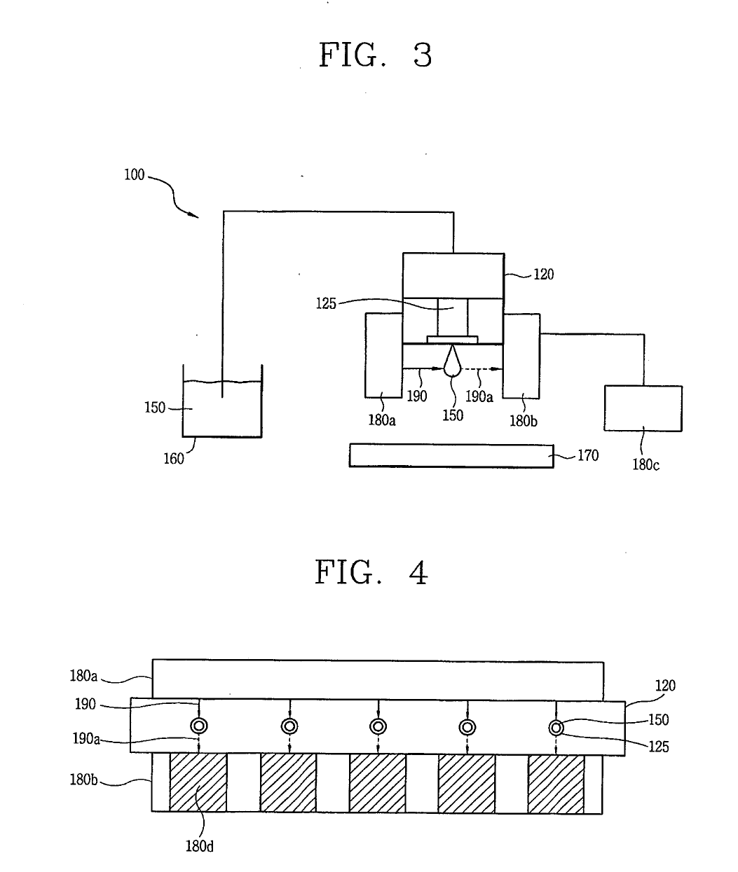

FIG. 2 is a schematic view showing an ink-jet printing device and a method for discharging a liquid material onto a printing medium using the ink-jet device according to an embodiment of the present invention. FIG. 3 is a schematic view of an ink-jet printing device according to an embodiment of the present invention. FIG. 4 is a schematic view showing a surface of the head in an ink-jet printing device according to the present invention.

As shown in FIG. 2, an ink-jet printing device 100 according to an embodiment of the present invention includes at least one head 120 for dispensing a liquid material 150 onto a printing medium 170, a liquid material supplying unit 160 for supplying the liquid material 150 to the head 120, and a liquid material supplying pipe 161 for connecting the liquid material supplying unit 160 to the head 120 so as to supply the liquid material 150 to the head 120. The head 120 is provided with a plurality of nozzles (not shown in FIG. 2). The amount of the liquid material 150 to be deposited onto the printing medium 170 is controlled by opening and closing the nozzles. The ink-jet printing device 100 is provided with a nozzle detecting unit 180 for real time (or in-situ) assessment of whether the nozzles are being nominally operated.

The dropping position of the liquid material is determined by positioning the head 120 with respect to the printing medium 170. Ink-jet printing is performed by either moving a stage 170a on which the printing medium 170 is located or by moving the head 120. Images 130 are selectively printed on the printing medium 170 while the head 120 scans across the printing medium. While the head 120 or the stage 170a is moved such that the head 120 scans across the printing medium, the nozzles of the head 120 are operated to dispense ink at a pressure that is than the full pressure capability of the nozzle to perform selective printing on the printing medium 170.

The ink-jet printing device in embodiments of the present invention can be used to fabricate a flat display device. For example, the ink-jet printing device in embodiments of the present invention can be used to print alignment material, to deposit spacer material, or to deposit a color filter material of an LCD device. In another example, the ink-jet printing device in embodiments of the present invention can be used to deposit a material for a layer of an electron emitting device.

A head unit of the ink-jet printing device 100 is includes at least one head 120 having a number of nozzles according to the size of the printing medium 170 and the amount time desired for printing. That is, if the printing medium 170 becomes larger, the number of the heads 120 and/or the number of the nozzles is increased to decrease printing time.

The ink-jet printing device according to an embodiment of the present invention is provided with the nozzle detecting unit 180 for real time assessing of whether the nozzle is discharging the proper amount of liquid material 150. As a result of such an assessment, the function of a defective nozzle can be replaced by a normal nozzle that dispenses the liquid material onto the print area corresponding to the defective nozzle or uses adjacent nozzles with increased flow-rates to compensate for the defective nozzle.

As shown in FIG. 2, the nozzle detecting unit 180 of the ink-jet printing device 100 includes an optical sensor 1 80b that corresponds to each of the nozzles in the head 120, and a controller 1 80c for driving the head 120 so as to replace the function of a defective nozzle by increasing the flow-rate of adjacent normal nozzles by increasing the flow-rate of adjacent normal nozzles or redirecting an adjacent normal nozzle over the print area corresponding to the area that the defective nozzle should have printed. The nozzle detecting unit 180 further includes a light emitter 180a mounted at one side of the head 120 for emitting light into a path of the liquid material discharged from the nozzles and an optical sensor 180b mounted at the other side of the head 120 for sensing light emitted from the light emitting portion 180 through the liquid material to detect an amount of the liquid material dispensed from the corresponding nozzle as well as the state of the corresponding nozzle. The intensity of the sensed light is used by a controller 180c to determine if the dispensed amount of the liquid material and the state of the nozzle in terms of whether the nozzle is blocked. If a nozzle is defective, the defective nozzle is no longer used and the function of the defective nozzle is replaced by adjacent nozzles having increased material flow-rate to prevent a defective print area due to the defective nozzle. For example, the flow-rates of a nozzle or nozzles adjacent to the defective nozzle can be increased to compensate for the loss of the defective nozzle. In another example, the head is rescanned over the area such that another nozzle is positioned to print in the area where a defective nozzle failed to print.

As shown in FIGS. 3 and 4, the optical units 180a and 180b of the nozzle detecting unit 180 are respectively attached at sides of the head 120, to assess each discharge of the liquid material 150 from each nozzle 125 of the head 120 and the state of each nozzle 125 in the head 120. The light receiving optical sensor 180b is provided with a plurality of light detecting areas 180d corresponding to each nozzle 125 for assessing each nozzle 125 of the head 120. The light emitting portion 180a emits light 190 into the path of the liquid material 150 discharged from the nozzles 125. Depending on a discharge state and a discharge amount of the liquid material 150 from the corresponding nozzle 125, an intensity of the light 190a received at the light receiving portion 180b changes. That is, when the emitted light 190 comes into contact with the liquid material 150, a large amount of the light 190 is reflected or absorbed by the liquid material 150. Therefore, whenever the liquid material 150 is discharged from the nozzles 125, the intensity of the light 190a transmitted to the light detecting areas 180d is lowered, which indicates that the liquid material 150 is being dispensed. In contrast, when the corresponding nozzle 125 is blocked by hardened materials or otherwise defective, the light detecting area 180d corresponding to the nozzle 125 consistently receives the light 190 having a certain intensity, which indicates that the liquid material 150 is not being normally discharged due to a defect of the nozzle 125.

The data obtained by the light receiving portion 180b is transmitted to the controller 180c of the nozzle detecting unit 180. Then, the controller 180c determines a defective nozzle 125 based on the received data, and drives the head 120 so that an adjacent normal nozzle 125 to the defective nozzle 125 can have an increased flow-rate or be redirected to dispense onto the defective print area instead of the defective nozzle 125. The optical sensors 180a and 180b are aligned with each other in the same direction as the head 120 moves. Therefore, when the liquid material 150 is discharged onto the printing medium 170, the discharge state of the liquid material 150 can be assessed in real time.

By real time detecting of a defective nozzle, a corresponding print area of the printing medium can be printed by another nozzle or compensated for by an increased flow-rate of an adjacent normal nozzle. As aforementioned, in the ink-jet device in embodiments of the present invention, each head is provided with the nozzle detecting unit for real time assessing of that the nozzle is being normally operated. Whether or not the liquid material is being discharged from the nozzle properly can be assessed by the nozzle detecting unit sensing the intensity of light passing through the path in which the liquid material discharges.

A method for fabricating an LCD device for using the ink-jet printing device according to the present invention will be explained. More particularly, a method for fabricating an LCD device by dispensing an alignment liquid will be explained.

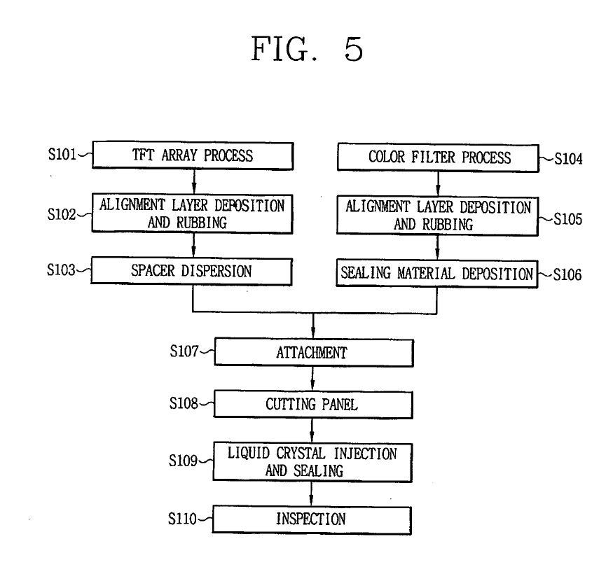

FIG. 5 is a flowchart of a method for fabricating a liquid crystal display device using the ink-jet printing device according to an embodiment of the present invention. Although not shown, the method for fabricating an LCD device according to an embodiment of the present invention can be divided into a driving device array process for forming a driving device on a lower substrate, a color filter process for forming a color filter on an upper substrate, and a cell process. As shown in FIG. 5, a plurality of gate lines and data lines for defining pixel regions are arranged on a lower substrate by the driving device array process. Then, a thin film transistor, a driving device, connected to the gate lines and the data lines is formed in each pixel region S101. A pixel electrode for driving a liquid crystal layer with a signal through the thin film transistor is also formed in the driving device array process.

On the upper substrate, R, G, and B color filter layers for displaying colors and a common electrode are formed by the color filter process S104. Next, an alignment layer is respectively deposited on the upper substrate and the lower substrate, and then the alignment layer is rubbed to provide an alignment controlling force, or a surface fixing force (that is, a pre-tilt angle and an alignment direction) to liquid crystal molecules of the liquid crystal layer formed between the upper substrate and the lower substrate. Then, a printing process using the ink-jet printing device for depositing the alignment layer will be explained with reference to FIGS. 2 to 4.

As shown in FIG. 2, the ink-jet printing process is performed by moving the head 120 or the stage 170a on which the printing medium 170 is located. Images 130 are selectively printed on a print area being scanned by the head 120. While the head 120 or the stage 170a moves, the nozzle of the head 120 is partially closed and performs a selective printing on the printing medium 170.

A head unit of the ink-jet printing device 100 includes at least one head 120 having a plurality of nozzles to dispense the liquid material 150 depending on the size of the printing medium 170. That is, as the printing medium 170 becomes larger, the number of the heads 120 or the number of the nozzles is increased to control the printing process time.

The ink-jet printing device according to an embodiment of the present invention is provided with the nozzle detecting unit 180 for real time assessing of whether the nozzle is discharging the proper amount of the liquid material 150 and foreign materials. As a result of such an assessment, the function of a defective nozzle can be replaced by a normal nozzle that dispenses the liquid material onto the print area corresponding to the defective nozzle or using adjacent nozzles have increased flow-rates to compensate for the defective nozzle.

As shown in FIG. 2, the nozzle detecting unit 180 of the ink-jet printing device 100 includes the optical sensing system 180a and 180b that correspond to each of the nozzles in the head 120, and the controller 180c for driving the head 120 so as to replace the function of a defective nozzle by increasing the flow-rate of adjacent normal nozzles by further opening the normal nozzles or redirecting an adjacent normal nozzle over the print area corresponding to the defective nozzle. The nozzle detecting unit includes the light emitting portion 180a mounted at one side of the head 120 for emitting light into a path of the liquid material discharged from the nozzles and the light receiving portion 180b mounted at the other side of the head 120 for sensing light emitted from the light emitting portion 180 through the liquid material to detect an amount of the liquid material dispensed from the corresponding nozzle as well as the state of the corresponding nozzle. The intensity of the sensed light is used by the controller 180c to determine if the dispensed amount and the state of the nozzle in terms of whether the nozzle is blocked. If a nozzle is defective, the defective nozzle is no longer used and the function of the defective nozzle is replaced by other nozzles having increased material flow-rate to prevent a defective print area due to the defective nozzle. For example, the flow-rates of nozzles on both sides of the defective nozzle can be increased.

As shown in FIGS. 3 and 4, the optical sensors 180a and 180b of the nozzle detecting unit 180 are respectively attached at sides of the head 120, to assess each discharge of the liquid material 150 from each head 120 and the state of each head 120. The light receiving portion 180b is provided with a plurality of light detecting areas 180d corresponding to each nozzle 125 for assessing each nozzle 125 of the head 120. The light emitting portion 180a emits light 190 to into the path of the liquid material 150 discharged from the nozzles 125. Depending on a discharge state and a discharge amount of the liquid material 150 from the corresponding nozzle 125, an intensity of light 190a received at the light receiving portion 180b changes. That is, when the emitted light 190 comes in contact with the liquid material 150, a large amount of the light 190 is reflected or absorbed by the liquid material. Therefore, whenever the liquid material 150 is discharged from the nozzles 125, the intensity of the light 190a transmitted to the light detecting areas 180d is lowered, which indicates that the liquid material 150 is being dispensed. In contrast, when the corresponding nozzle 125 is blocked by hardened materials or otherwise defective, the light detecting area 180d corresponding to the nozzle 125 consistently receives the light 190 having a certain intensity, which indicates that the liquid material 150 is not being normally discharged due to a defect of the nozzle 125.

The data obtained by the light receiving portion 180b is transmitted to the controller 180c of the nozzle detecting unit 180. Then, the controller 180c determines the defective nozzle 125 based on the received data, and drives the head 120 so that an adjacent normal nozzle 125 to the defective nozzle 125 can have an increased flow-rate or be redirected to dispense onto the defective print area instead of the defective nozzle 125. The optical sensors 180a and 180b are aligned with each other in the same direction as the head 120 moves. Therefore, when the liquid material 150 is discharged onto the printing medium 170, the discharge state of the liquid material 150 can be assessed in real time.

By real time detecting a of defective nozzle, a corresponding printing area of the printing medium can be printed by another nozzle or compensated for by an increased flow-rate of an adjacent normal nozzle. As aforementioned, in the ink-jet device in embodiments of the present invention, each head is provided with the nozzle detecting unit for real time certifying whether or not the nozzle is being normally operated. Whether or not the liquid material is being discharged from the nozzle properly can be assessed by the nozzle detecting unit sensing the intensity of a light passing through the path of the liquid material. After dispensing the liquid material, a rubbing process is performed.

As shown in FIG. 5, a spacer for constantly maintaining a cell gap is dispersed on the lower substrate S103, and then a sealing material is deposited at an outer periphery of the upper substrate S106. The upper substrate and the lower substrate are both formed of a large glass plate. Next, the upper substrate and the lower substrate are attached to each other using pressure S107 to form a large glass substrate. A plurality of panel regions are formed in the large glass substrate, and a driving device, a TFT and a color filter layer are formed at each panel region. Then, the glass substrate has to be cut and processed to fabricate individual liquid crystal panels S108.

Next, the liquid crystal is injected into each of the processed individual liquid crystal panels through a liquid crystal port, and then the liquid port is sealed to form a liquid crystal layer S109. Then, each liquid crystal panel is inspected S110. As aforementioned, in the ink-jet printing method in embodiments of the present invention, the nozzle detecting unit is provided to perform real time assessing to detect a defective nozzle. When a defective nozzle is detected, the effect of the defective nozzle can be immediately compensated, thereby minimizing a loss of a processing time and minimizing a difference between a normal print area and a compensated print area. Accordingly, even if the head has a defective nozzle, the head can be continuously used without degrading print quality.

It will be apparent to those skilled in the art that various modifications and variations can be made in an ink-jet printing device and a method for fabricating an LCD device using the same of the present invention without departing from the spirit or scope of the invention. Thus, it is intended that the present invention cover the modifications and variations of this invention provided they come within the scope of the appended claims and their equivalents.

What is claimed is:

1. An ink-jet printing device, comprising:
at least one head including a plurality of nozzles;
a nozzle detecting unit; and
a liquid material supplying unit.

2. The device of claim 1, wherein the nozzle detecting unit includes:
a plurality of optical sensors corresponding to each of the nozzles; and
a controller for driving the head.

3. The device of claim 2, wherein the optical sensors includes:
a light emitting portion mounted at one side of the head; and
a light receiving portion mounted at another side of the head.

4. The device of claim 1, further comprising a liquid material supplying pipe for connecting the liquid material supplying unit to the head.

5. The device of claim 1, wherein the liquid material includes one of an alignment material, a spacer material and a color filter material of a liquid crystal display.

6. The device of claim 1, wherein the liquid material includes a material for a layer of an electronic emitting device.

7. A method for fabricating an liquid crystal display device using an ink-jet printing device, comprising:
preparing at least one head having a plurality of nozzles;
assessing whether a liquid material is normally discharged from each of the nozzles; and
supplying the liquid material to the head.

8. The method of claim 7, wherein the step of assessing whether liquid material is discharged from each of the nozzles includes:
real time assessing of a discharge state of the liquid material while the liquid material is discharged onto a printing medium; and
controlling the head so as to replace a function of a defective nozzle with a normal nozzle.

9. The method of claim 8, wherein the step of real time assessing of a discharged state of the liquid material is performed by a light emitting portion mounted at one side of the head for emitting light into a moving path of the liquid material discharged from the nozzles, and a light receiving portion mounted at another side of the head for sensing light emitted from the light emitting portion, and detecting an amount of the liquid material discharged from a corresponding nozzle and a state of the corresponding nozzle according to intensity of the sensed light.

10. The method of claim 7, wherein the liquid material includes one of an alignment material, a spacer material and a color filter material of a liquid crystal display.

11. The device of claim 7, wherein the liquid material to be dispensed includes a material for a layer of an electron emitting device.

12. The method of claim 7, wherein in the step of assessing whether liquid material is discharged from each of the nozzles includes determining whether the nozzle is blocked.

13. A method for fabricating an liquid crystal display device using an ink-jet printing device, comprising:
providing first and second substrates;
forming a plurality of thin film transistor arrays on the first substrate;
forming a color filter on the second substrate;
supplying liquid alignment material to the first and second substrates through at least one head having a plurality of nozzles;
assessing whether the liquid alignment material is normally discharged from the nozzles; and
depositing the liquid alignment material discharged from the nozzles on the first and second substrates to form alignment layers on the first and second substrates.

14. The method of claim 13, wherein the step of assessing whether the liquid alignment material is discharged from the nozzles is performed by a plurality of optical sensors corresponding to the nozzles, and a controller for driving the head so as to replace a function of a defective nozzle with a normal nozzle.

15. The method of claim 14, wherein the optical sensors includes:
a light emitting portion mounted at one side of the head for emitting light into a path of the liquid material discharged from the nozzles;
a light receiving portion mounted at another side of the head for sensing light emitted from the light emitting portion; and
a controller detecting an amount of the liquid material discharged from a corresponding nozzle and a state of the corresponding nozzle according to intensity of the sensed light.

16. A method for fabricating an liquid crystal display device using an ink-jet printing device, comprising:
providing first and second substrates;
forming a plurality of thin film transistor arrays on the first substrate;
forming a color filter on the second substrate;
supplying liquid material to the first and second substrates through at least one head having a plurality of nozzles;
assessing whether the liquid alignment material is normally discharged from the nozzles;
depositing the liquid alignment material discharged from the nozzles on the first and second substrates to form alignment layers on the first and second substrates;
performing a rubbing process on the alignment layer;
attaching the first substrate and the second substrate to each other; and
forming a liquid crystal layer between the first substrate and the second substrate.

17. The method of claim 16, wherein the step of assessing whether the liquid alignment material is discharged from the nozzles is performed by a plurality of optical sensors corresponding to the nozzles, and a controller for driving the head so as to replace a function of a defective nozzle with a normal nozzle.

18. The method of claim 17, wherein the optical sensor includes:
a light emitting portion mounted at one side of the head for emitting light onto a moving path of the liquid material discharged from the nozzles;
a light receiving portion mounted at another side of the head for sensing light emitted from the light emitting portion; and
a controller detecting an amount of the liquid material discharged from a corresponding nozzle and a state of the corresponding nozzle according to intensity of the sensed light.
